(19) United States
(12) Patent Application Publication
(10) Pub. No.: US 2005/0257978 A1
(43) Pub. Date: Nov. 24, 2005

(54) Motorcycle handlebar vibration damper

(76) Inventor: Todd Sigfrid, Brooklyn Park, MN (US)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/850,343

(22) Filed: May 20, 2004

(51) Int. Cl. B62D 61/02

(52) U.S. Cl. 180/219

(57) ABSTRACT

A motorcycle handlebar assembly is described as having a main handlebar tube and first and second grip assemblies respectively coupled at opposite end regions of the tube. The grip assemblies each comprise a sealed hollow chamber with a volume of lead balls located in the sealed hollow chambers to provide vibration damping. A method of reducing vibration conducted to hands of a rider of a motorcycle is described to provide sealed chambers located at a grip location of a motorcycle handlebar and partially filling the sealed chamber with loose material.

### FIELD OF THE INVENTION

The present invention relates to motorcycle handlebars. More particularly the present invention relates to handlebars that provide vibration dampening.

### BACKGROUND OF THE INVENTION

Motorcycles typically include handlebars that are used by an operator to steer the motorcycle. As such, the operator's hands are in contact with the handlebars. FIG. 1 illustrates a schematic view of a conventional steering system 100 for a motorcycle. A top bridge 102 is rotatably attached to a head 101 of the motorcycle frame, and a handlebar 103 is attached to the top bridge 102 by handlebar holders 104. In operation the rider holds onto hand grips 107. FIG. 1 is simplified and does not show operating controls, such as clutch and brake levers.

To improve the steering system 100 by enhancing the vibration-reduction effect of the handlebar 103 a cushioning member can be provided in the steering system 100 to absorb vibration for the purpose of improved driving of a motorcycle. The use of only the cushioning member, such as rubber mounts, in the conventional steering system, however, is not enough to obtain a vibration-proof effect in all motorcycles. What is desired is an improved motorcycle handlebar that provides vibration damping at the handgrip locations.

### BRIEF SUMMARY OF THE INVENTION

In one embodiment, a handlebar assembly comprises a main tube having first and second end regions and first and second grip assemblies respectively located at the first and second end regions. The grip assemblies each comprise a sealed hollow chamber and loose fill material is located in the sealed hollow chambers.

In another embodiment, a motorcycle handlebar assembly comprises a main handlebar tube having first and second end regions, and first and second grip assemblies respectively threadingly attached at the first and second end regions. The grip assemblies each comprise a sealed hollow chamber containing a plurality of lead balls to provide vibration damping.

A motorcycle handlebar damping insert comprises a tubular body having a hollow core, wherein an outside diameter of the tubular body is sized to fit within a handlebar tube of a motorcycle. First and second end caps are respectively located at end regions of the tubular body to seal the hollow core and define a chamber within the tubular body. A plurality of lead balls are located within the chamber.

These and other features of the invention will be more apparent from the following detailed description that is provided in connection with the accompanying drawings and illustrated exemplary embodiments of the invention.

### BRIEF DESCRIPTION OF THE DRAWINGS

FIG. 1 illustrates a simplified prior art motorcycle handlebar.

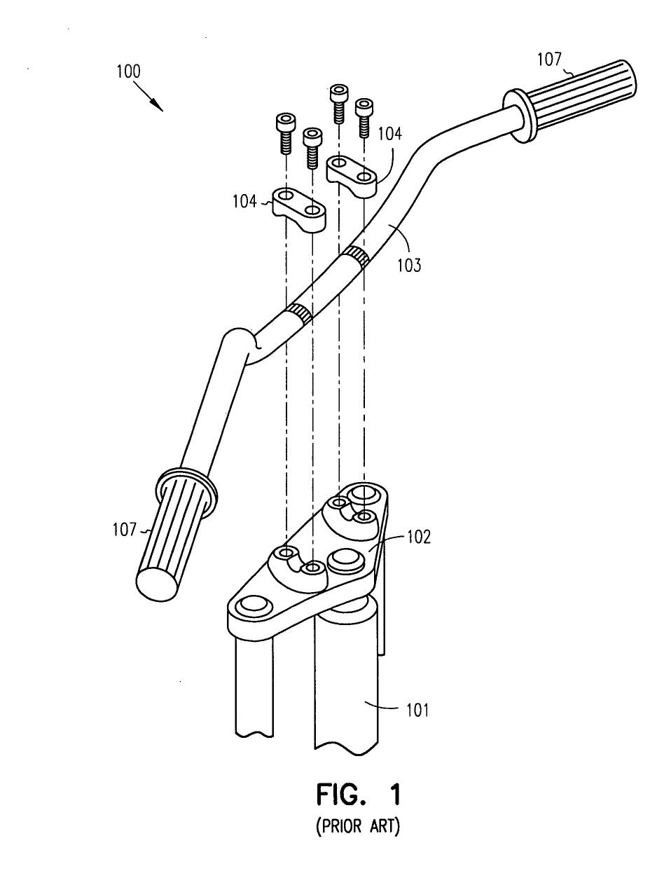

FIG. 2 illustrates one embodiment of a motorcycle of the present invention.

FIGS. 3A and 3B illustrate a handlebar assembly of one embodiment of the present invention.

FIGS. 4 and 5 illustrate alternate handlebar embodiments of the present invention.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized, and that structural changes may be made without departing from the present invention.

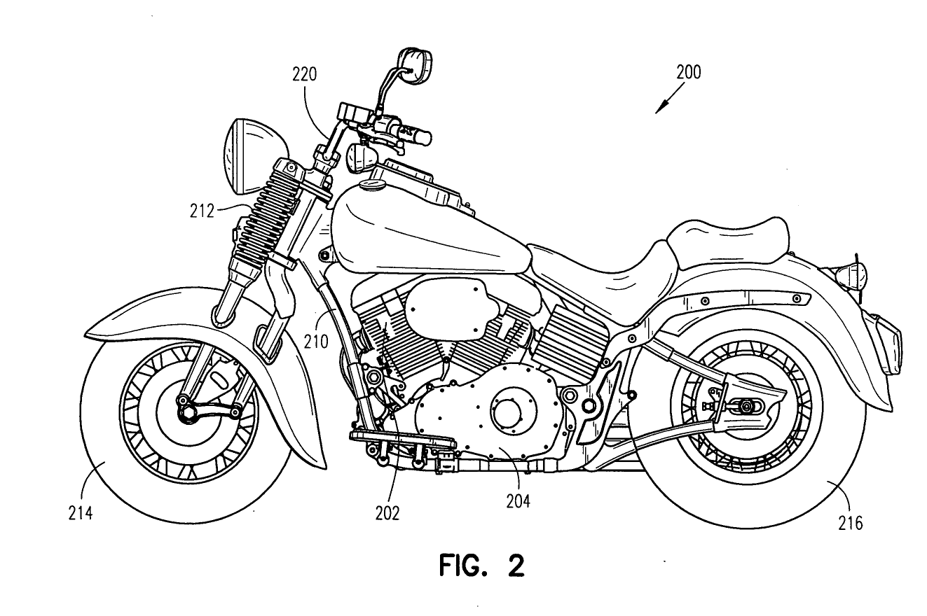

With reference initially to FIG. 2, a motorcycle 200 of one embodiment of the present invention is illustrated. The motorcycle is powered by an engine 202 through a transmission 204 and drive train. As is known to those of ordinary skill in the art, the motorcycle is generally comprised of a frame 210 assembly upon which the engine is attached. This frame assembly also supports a front fork assembly 212 to which a front wheel 214 is mounted. A rear wheel 216 is mounted to the frame 210 assembly in any suitable manner. A handlebar assembly 220 is provided to turn the front fork 212 and front wheel 214. The handlebar assembly is mounted to the fork via a steering head. To help reduce vibration transmitted to the rider's hands the handlebars can be attached to the fork using vibration isolation mounts (not shown). While this helps to reduce the transmission of vibration, the handlebars of an embodiment of the present invention include additional damping at the rider's hand grip locations, as detailed below.

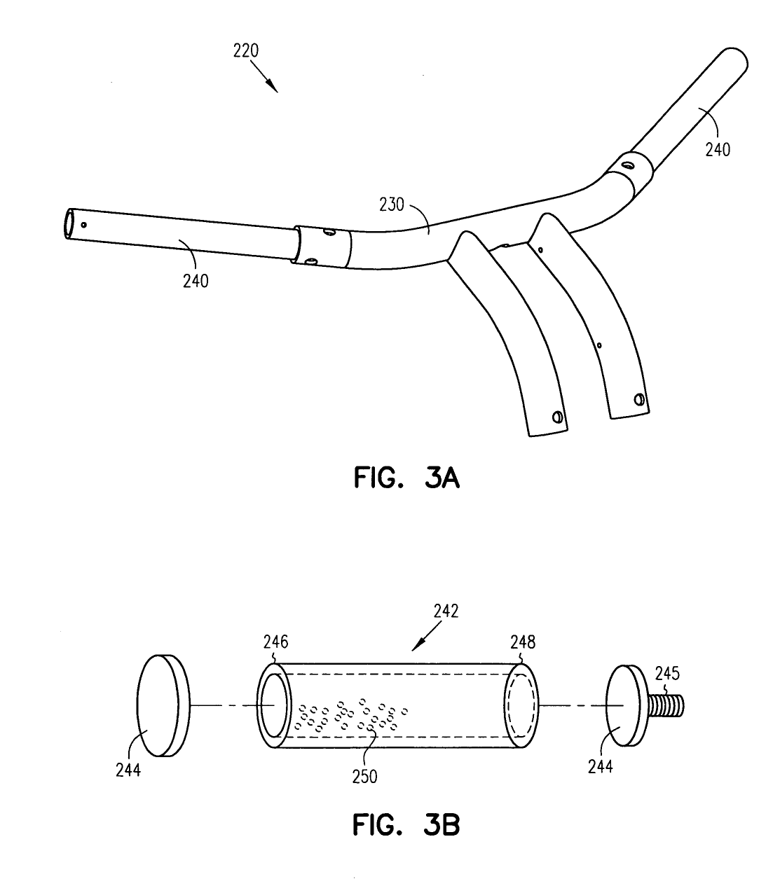

Referring to FIGS. 3A and B, a detailed illustration of a handlebar assembly 220 embodiment is described. The handlebar assembly includes a main tube 230 and two grip assemblies 240 attached to ends of the main tub. The main tube can be either hollow or solid. In this embodiment the two grip assemblies are sealed tubes that are removable from the main tube, such as using a threaded connection. The main tube and grip assemblies can be fabricated from any suitable material, such as steel. Each grip assembly 220 is formed from a tube 242 and two end caps 244. The end caps are attached to ends 246 and 248 of the tube 242, such as by welding, to form a sealed interior chamber of the tube. One end cap includes a threaded connector 245 to attach to the main tube. The chamber is partially filled with loose material 250 to dampen vibration transmitted to the ends of the main tube 230. The loose material comprises lead balls having a small diameter. In one embodiment the ball diameter is less than about 0.15 inches, and can be about 0.08 inches. The present invention is not limited, however, to a specific size, shape or material. It has been determined that satisfactory vibration reduction can be accomplished by filling the hollow core approximately one-half full of loose lead material. It will be appreciated that an effective amount of loose material can vary between handlebar designs. Further, alternate loose material can be substituted for lead.

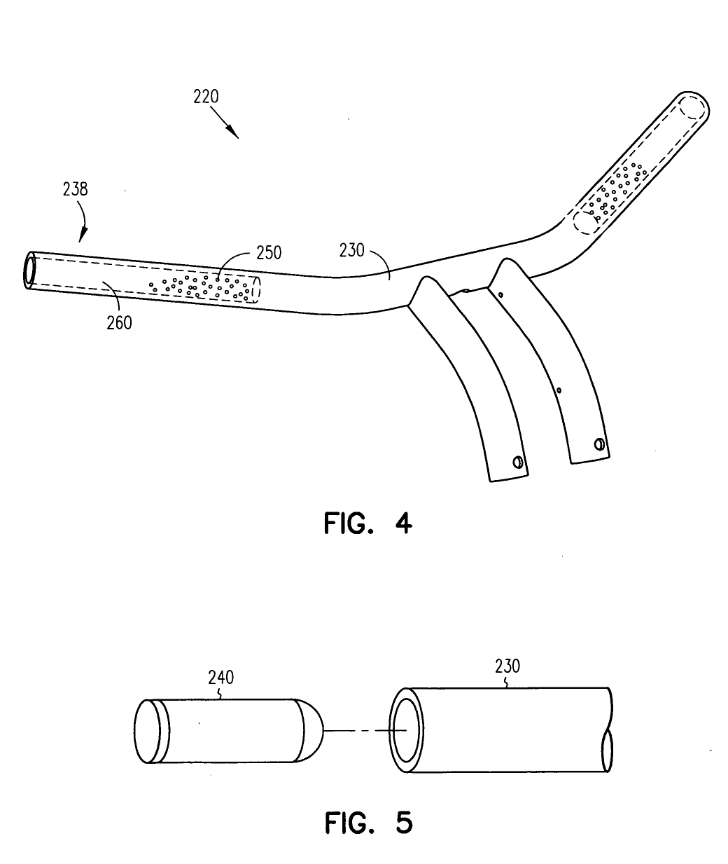

In alternate embodiments the grip assemblies and main tube can be manufactured such that they form one complete unit. That is, the end regions 238 of the main tube 230 can be sealed to form chambers 260 in which the loose material 250 is located, see FIG. 4. Further, the grip assemblies 240 can have a smaller outside diameter than the inside diameter of the main tube 230 so that the grip assemblies can fit inside the main tube as an insert, FIG. 5. In this embodiment, the grip assemblies can be made from metal or plastic and used to retrofit existing motorcycle handlebars for vibration reduction. As described above, these grip assemblies contain a volume of loose material to provide vibration reduction. Although the illustrated embodiments include two end caps, it will be appreciated that in some embodiments one of the end caps can be integrally formed with the tube and only one end cap would be needed to seal the chamber.

The grip assemblies can be manufactured using two different methods. The first method comprises forming the chamber after placing the loose material. That is, one end cap of the grip assembly is attached to the tube, the loose fill is placed in the tube and the other end cap is attached to the tube to define and seal the chamber. In an embodiment where the end caps are welded to the tube and the loose fill has a low melting point, a thermal heat sink may be needed when attaching the second end cap such that the fill does not melt and form a solid mass. In an alternate embodiment, the end caps of the assemblies are attached prior to placing the fill. In this embodiment an access hole is used to place the loose fill inside the chamber and then the access hole is plugged to retain the loose fill.

The above description and drawings are to be considered illustrative of exemplary embodiments that achieve the features and advantages of the invention. Although exemplary embodiments of the present invention have been described and illustrated herein, many modifications, even substitutions of materials, can be made without departing from the invention. It is not intended that the invention be limited to the embodiments shown and described in detail herein. The invention is limited only by the scope of the appended claims.

1. A handlebar assembly comprising:
a main tube having first and second end regions;
first and second grip assemblies respectively located at the first and second end regions, wherein the grip assemblies each comprise a sealed hollow chamber; and
loose fill material located in the sealed hollow chambers.

2. The handlebar assembly of claim 1 wherein the first and second grip assemblies are respectively attached to the first and second end regions using a threaded connector.

3. The handlebar assembly of claim 1 wherein the first and second grip assemblies are respectively located within the main tube at the first and second end regions.

4. The handlebar assembly of claim 3 wherein the first and second grip assemblies are formed from plastic.

5. The handlebar assembly of claim 1 wherein the loose fill material comprises lead balls.

6. The handlebar assembly of claim 5 wherein the lead balls have a diameter of less than 0.15 inches.

7. A motorcycle handlebar assembly comprising:
a main handlebar tube having first and second end regions;
first and second grip assemblies respectively threadingly attached at the first and second end regions, wherein the grip assemblies each comprise a sealed hollow chamber; and
a plurality of lead balls located in the sealed hollow chambers to provide vibration damping.

8. The motorcycle handlebar assembly of claim 7 wherein the lead balls have a diameter of less than 0.15 inches.

9. The motorcycle handlebar assembly of claim 7 wherein the plurality of lead balls fill about one-half of the volume of each of the sealed hollow chambers.

10. A motorcycle handlebar damping insert comprising:
a tubular body having a hollow core, wherein an outside diameter of the tubular body is sized to fit within a handlebar tube of a motorcycle;
at least one end cap located at an end region of the tubular body to seal the hollow core and define a chamber within the tubular body; and
a plurality of lead balls located within the chamber.

11. The motorcycle handlebar damping insert of claim 10 comprises two end caps.

12. A motorcycle comprising:
a frame;
a front fork assembly attached to the frame for supporting a front wheel;
a handlebar attached to the front fork assembly to allow movement of the front wheel for steering the motorcycle during operation; and
handlebar vibration damping assemblies coupled to the handlebar, wherein the handlebar vibration damping assemblies comprise:
a tubular body having a hollow core,
first and second end caps respectively located at end regions of the tubular body to seal the hollow core and define a chamber within the tubular body, and
a plurality of lead balls located within the chamber to provide vibration damping.

13. The motorcycle of claim 12 wherein the handlebar vibration damping assemblies are threadingly attached to ends of the handlebar.

14. The motorcycle of claim 12 wherein the handlebar vibration damping assemblies are located within ends of the handlebar.

15. The motorcycle of claim 12 wherein the lead balls have a diameter of less than 0.15 inches.

16. The motorcycle of claim 12 wherein the plurality of lead balls fill about one-half of the volume of each of the chambers.

17. A method of reducing vibration conducted to hands of a rider of a motorcycle comprising:
providing a sealed chamber located at a grip location of a motorcycle handlebar; and
partially filling the sealed chamber with loose material.

18. The method of claim 16 wherein the loose material is lead balls having a diameter of less than about 0.15 inches.
